(19) United States
(12) Patent Application Publication
(10) Pub. No.: US 2021/0234498 A1
(43) Pub. Date: Jul. 29, 2021

(54) THERMOPHOTOVOLTAIC SYSTEM AND METHOD OF MAKING THE SAME

(71) Applicant: Purdue Research Foundation, West Lafayette, IN (US)

(72) Inventors: Esteban Marinero-Caceres, West Lafayette, IN (US); Arnold Toppo, West Lafayette, IN (US); Sajid Choudhury, West Lafayette, IN (US); Urcan Guler, West Lafayette, IN (US); Zhaxylyk Kudyshev, West Lafayette, IN (US); Joseph Pekny, West Lafayette, IN (US); Swati Pol, West Lafayette, IN (US); Harsha Reddy, West Lafayette, IN (US); Vladimir Shalaev, West Lafayette, IN (US)

(73) Assignee: Purdue Research Foundation, West Lafayette, IN (US)

(21) Appl. No.: 16/865,192

(22) Filed: May 1, 2020

Related U.S. Application Data
(60) Provisional application No. 62/966,674, filed on Jan. 28, 2020.

(51) Int. Cl. H02S 10/30; H02S 30/00; H02S 40/20

(52) U.S. Cl. CPC H02S 10/30; H02S 40/20; H02S 30/00

(57) ABSTRACT

A system including a first cylindrical structure embedded into a second cylindrical structure. The first cylindrical structure includes a combustion chamber. The first cylinder additionally includes a plurality of plasmonic materials on an outer wall of the first cylindrical structure. The second cylindrical structure includes a plurality of photovoltaic cells on an inner wall of the second cylindrical structure. A radius of the second cylindrical structure is greater than a radius of the first cylindrical structure.

### CROSS-REFERENCE TO RELATED APPLICATIONS

The present U.S. Patent Application is related to and claims the priority benefit of U.S. Provisional Patent Application Ser. No. 62/966,674, filed Jan. 28, 2020, the contents of which is hereby incorporated by reference in its entirety into this disclosure.

### TECHNICAL FIELD

This disclosure relates to a thermophotovoltaic system, method of using the same, and method of making the same.

### BACKGROUND

This section introduces aspects that may help facilitate a better understanding of the disclosure. Accordingly, these statements are to be read in this light and are not to be understood as admissions about what is or is not prior art.

Most Conventional thermophotovoltaic systems operate on the basis of solar energy. Due to the inherent design constraints associated with thermophotovoltaic systems that operate on the basis of solar energy, such thermophotovoltaic systems have limited versatility. Hence, there is a need for thermophotovoltaic systems with increased versatility that operate on the basis of waste heat, chemical reactions, fossil fuels, radioisotopes, and solar energy.

### SUMMARY

Various embodiments of the present application relate to thermophotovoltaic systems that use photonic metasurface concepts and materials for direct energy conversion from heat to electric power that are expected to provide unprecedented high conversion efficiencies. A proposed thermophotovoltaic (TPV) platform is based on refractory plasmonic metasurface/metamaterial device structures. We utilize a new class of high-temperature stable, durable and low cost optical materials that overcome the limitations of conventional TPV devices.

In recent years, there has been significant research interest in engineering the optical and spectral properties of materials through the use of photonic metasurfaces for efficient energy conversion and sensing applications, including thermophotovoltaics and harsh environment sensors. For example, it has been theoretically predicted that by judiciously tailoring the spectral properties of the emitters and absorbers components using metasurfaces, the efficiency for direct energy conversion from solar/thermal energy to electricity could potentially reach an unprecedented value of about 85%. This is in contrast to the current physical limitation of around 30% imposed by the Shockley-Queisser limit in single silicon p-n junction cells.

An impediment in the realization of such ultra-efficient TPV devices has been the lack of photonic materials capable of withstanding the extremely high temperatures required. In TPV systems, thermal radiation is directly converted to electricity via the photovoltaic (PV) effect. FIG. 1 illustrates schematics of the technical approach for thermophotovoltaic(TPV) prototype development. TPV energy conversion offers numerous significant advantages over competing technologies. These include the realization of highly versatile, modular, low-weight and compact electricity generators (portable and stationary) that are noiseless, low-maintenance and energy-efficient. A plurality of energy sources can be employed for TPV systems operation. These include waste heat, chemical reactions, fossil fuels, radioisotopes, and solar energy, or combinations thereof, thereby making them attractive in a wide variety of commercial and military sectors such as: automotive, aeronautic and space industries, power plants, oil and gas exploitation, metal foundries, household needs, and for military special forces and expeditionary missions.

One aspect of the present application relates to a system including a first cylindrical structure embedded into a second cylindrical structure. The first cylindrical structure includes a combustion chamber. The first cylinder additionally includes a plurality of plasmonic materials on an outer wall of the first cylindrical structure. The second cylindrical structure includes a plurality of photovoltaic cells on an inner wall of the second cylindrical structure. A radius of the second cylindrical structure is greater than a radius of the first cylindrical structure. For the case of non-cylindrical objects, the distance from the plane of the outermost object from the coaxial axis is greater than that of the first non-cylindrical object.

Another aspect of the present application relates to a system including a first cylindrical structure embedded into a second cylindrical structure. Other structural geometries such as rectangular, triangular or polyhedral co-axial objects are also considered. The first cylindrical structure includes a chamber, wherein the chamber includes an isotope. The first cylinder additionally includes a plurality of plasmonic materials on an outer wall of the first cylindrical structure. The second cylindrical structure includes a plurality of photovoltaic cells on an inner wall of the second cylindrical structure. A radius of the second cylindrical structure is greater than a radius of the first cylindrical structure.

Still another aspect of the present application relates to a method of using a thermophotovoltaic system including reacting a chemical in a chamber of a first cylindrical structure, wherein the first cylindrical structure includes the chamber. The method additionally includes radiating heat from the chamber onto a plurality of plasmonic materials, wherein the plurality of plasmonic materials are on an outer wall of the first cylindrical structure. The method further includes emitting a wavelength from the plurality of plasmonic materials onto a plurality of photovoltaic cells, wherein a second cylindrical structure includes the plurality of photovoltaic cells. The first cylindrical structure is embedded into the second cylindrical structure. The wavelength emitted from the plurality of plasmonic materials is commensurate with a bandgap of the plurality of photovoltaic cells. Moreover, the method includes producing electric charge from the plurality of photovoltaic cells.

Still another aspect of the invention relates to a method of using an optically transparent vacuum-sealable enclosure disposed between the inner and outer co-axial bodies to maintain the surface temperature of the photovoltaic cells within their normal operating temperature range, which for maximum efficiency in the case of Si cells, it ranges from 15° C. to 35° C. Examples of materials suitable for the system are quartz, fused silica, sapphire, BaF₂, CaF₂, Lif and MgF₂ amongst other.

### BRIEF DESCRIPTION OF DRAWINGS

One or more embodiments are illustrated by way of example, and not by limitation, in the figures of the accompanying drawings, wherein elements having the same reference numeral designations represent like elements throughout. It is emphasized that, in accordance with standard practice in the industry, various features may not be drawn to scale and are used for illustration purposes only. In fact, the dimensions of the various features in the drawings may be arbitrarily increased or reduced for clarity of discussion.

FIG. 1 illustrates schematics of the technical approach for thermophotovoltaic(TPV) prototype development.

FIG. 2 illustrates operating principles of a TPV system.

FIG. 3(a) illustrates emittance spectra of the optimized emitters for GaSb PV cells (h₁=200 nm, h₂=142 nm, h_{c}=30 nm, U=145 nm). FIG. 3(b) illustrates emittance spectra of the corresponding optimized emitter for silicon PV cells (h₁=200 nm, h₂=40 nm, h_{c}=100 nm, U=200 nm)

FIG. 4 illustrates a schematic representation of the TPV device geometry.

FIG. 5(a) illustrates computational results for the output power generated employing GaSb PV cells. FIG. 5(b) illustrates computational results for the output power generated employing silicon PV cells

FIG. 6 illustrates design of the combustion chamber.

FIG. 7(a) illustrates temperature distribution and density distribution of the fuel mixture.

FIG. 7(b) illustrates temperature distribution within the combustion chamber during the fuel burning process.

FIG. 8(a) illustrates a 3D sketch of the combustion chamber enclosed within a quartz envelope. FIG. 8(b) illustrates side view and cross-section of the combustion chamber equipped with the quartz enclosure.

FIG. 9 illustrates dependence of the average temperature of the PV array on air flow velocity for different ambient pressures in the enclosure between the quartz cylinder and the combustion chamber.

FIG. 10 illustrates schematics of the assembled TPV prototype.

FIG. 11 illustrates cross sectional and lateral view of the combustion chamber with the emitters.

FIG. 12 illustrates schematics of the assembled TPV prototype with cooling system of PV cell array.

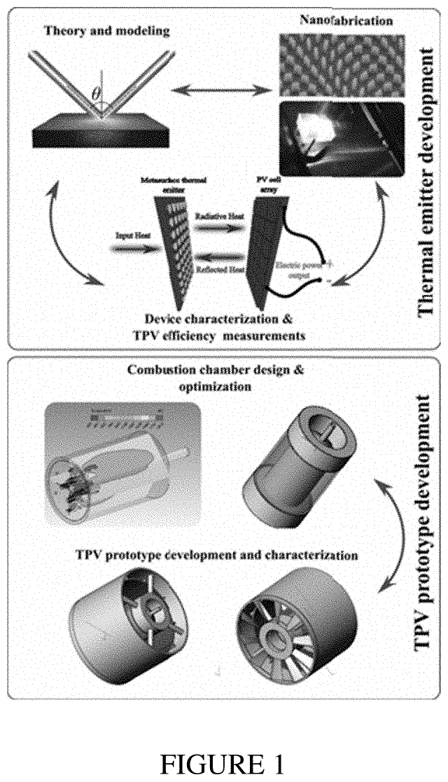

### DETAILED DESCRIPTION

For the purposes of promoting an understanding of the principles of the disclosure, reference will now be made to the embodiments illustrated in the drawings and specific language will be used to describe the same. It will nevertheless be understood that no limitation of the scope of the disclosure is thereby intended.

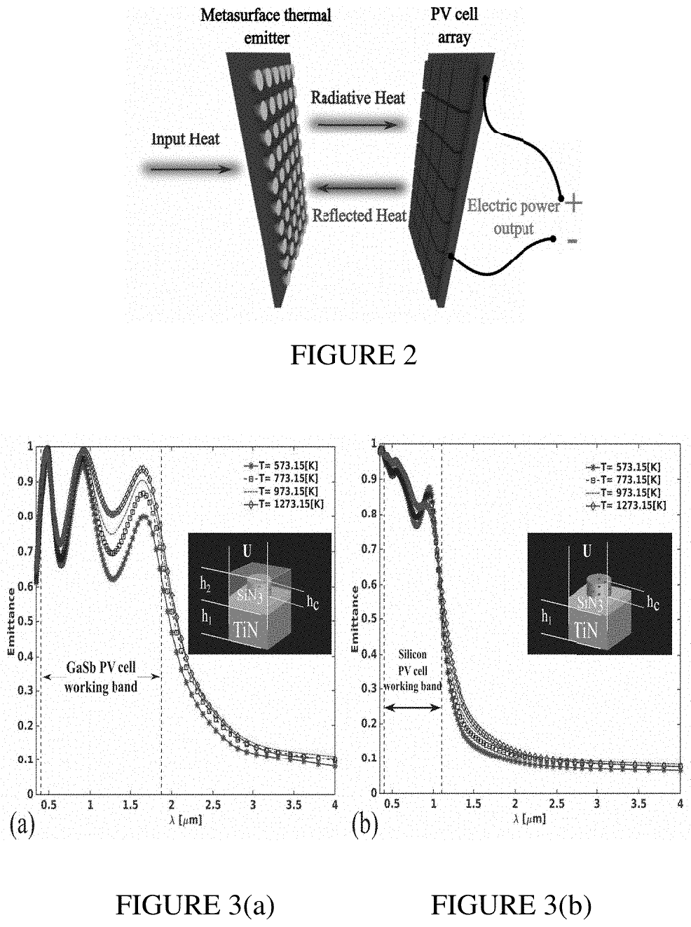

FIG. 2 illustrates operating principles of a TPV system. Compared to solar PV conversion, the heat source in a TPV device, is significantly closer to the PV cells, resulting in photon fluxes and power densities at the cells that are orders of magnitude higher. The typical temperatures required for practical TPV systems (1200-2000K), entail that the majority of the emitted photons are in the near-to mid-infrared regions of the electromagnetic spectrum. Therefore, for optimum TPV devices, high quality low band gap PV cells are necessary, together with emitters whose spectral emission match the band gap of said PV cells. One possible way to manipulate the spectral wavelength of emitted radiation is to use selective emitters to match the absorption maximum of the PV cell. Various selective emitters have been investigated including rare-earth oxides and photonic crystals. Another effective method of spectral control is to use selective filters for recuperating low energy/non-convertible photons.

Another approach is the use of metamaterial-based emitters, for efficient thermal photon conversion. Optimum TPV energy conversion requires high emitter temperatures and large operational areas; hence, robust refractory materials, which are compatible with low-cost, large-area fabrication techniques, are a key solution for practical highly efficient TPV devices. Transition metal nitrides (TMNs) such as TiN are refractory materials with plasmonic properties in the visible and near infrared regions. Their plasmonic properties are manipulated in our work by judicious control of their microstructure. They are stable and mechanically robust at high temperatures and are easily fabricated using inexpensive and efficient large-throughput sputter deposition thin film growth techniques.

Refractory metamaterials composed of TMNs are a solution to the long-standing problem of providing spectral control capabilities of plasmonics materials together with high temperature stability. TPV devices employing refractory metals such as W, Mo and Ta require photonic crystal designs with structural dimensions comparable to the wavelength of light, thereby necessitating the use of complex geometries to achieve a spectrally selective optical response. This can entail costly fabrication. Moreover, grain boundary migration at high temperatures in these polycrystalline materials, results in mechanical deformation that rapidly degrades the energy conversion efficiency. To reduce TPV operating temperatures, a technology, employs near-field enhancement of the radiative energy transfer. This requires positioning of the emitter and the PV cells at distances not exceeding tens of nanometers.

The metamaterial emitters are ultra-thin films with thicknesses on the nanometer scale with optimal surface-to-volume ratio. The plasmonic metasurfaces are designed to efficiently emit electromagnetic radiation with predefined wavelengths to match the bandgap of commercial PV cells such s Si, GaSb and InGaAs cells. Various embodiments of the present application employ TPV metamaterial designs that are based on planar geometries and are amenable to large-scale fabrication through nanoimprint lithography.

Maximum energy conversion efficiency in a TPV system is attained when the emitter's peak emission occurs at wavelengths that match the PV cell's working frequency band, while simultaneously suppressing emission in the non-convertible range. In addition, the emitters are need to be stable at operating temperatures of up to 2000K over extended time periods. These requirements severely hinder the materials and nanostructures that can be used. A solution is to employ emitter metasurface configurations fabricated from transition metal nitrides (specifically, titanium nitride, TiN). To simplify fabrication, we select the emitter geometry to be a plasmonic cylindrical emitter that exploits gap/surface plasmon resonances (see FIGS. 3a and 3b). This design allows simultaneous near-blackbody emittance at short wavelengths and low emission at long wavelengths. A sharp cutoff separates the two regimes, which is critical for high efficiency TPV energy conversion.

Various designs are optimized to maximize TiN metasurface emission for both GaSb and silicon PV cell working bands. The results presented in FIGS. 3a and 3b are based on measurements of the optical properties of TiN at the temperatures indicated by employing variable angle spectroscopic ellipsometer measurements. The emittance spectra at different temperatures are shown in FIG. 3a for GaSb and FIG. 3b for silicon PV cells.

Fabrication of the plasmonic emitters involves the following steps: a) TiN/Si₃N₄/TiN film stacks are grown on sapphire substrates using DC magnetron sputtering at 800° C. to ensure epitaxial growth of the TiN films; b) the emitter metasurface structure is patterned onto the thin film stack employing nanoimprint lithography to form the optimized cylindrical pillars (see FIG. 3); c) the topmost TiN layer is removed via reactive ion etching; d) a protective Si₃N₄ overcoat is deposited for environmental protection against oxidation of TiN.

The design of a TPV system to provide a target value of electrical power generation requires optimization of all critical elements comprising the device that includes as already discussed the metasurface emitters, as well as the combustion chamber and thermal heat management. As an example in this application, we illustrate the steps required to design, fabricate and optimize a combustion chamber using natural gas fuel to build a TPV prototype system capable of generating a nominal electric power output of 3.5 kW-hr.

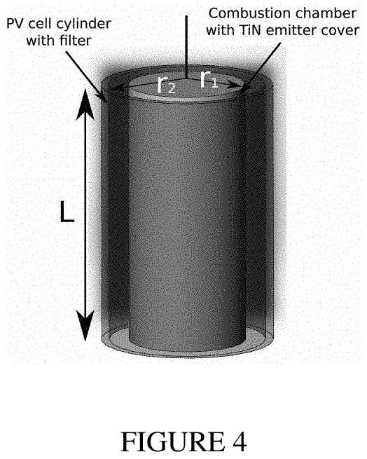

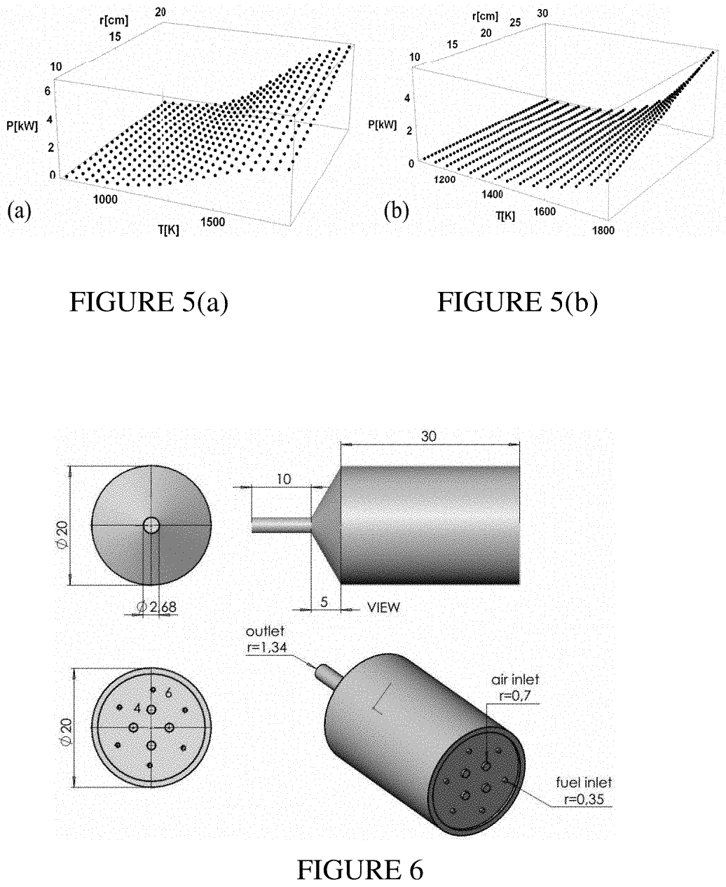

To determine the generated electrical power from a TPV device with cylindrical geometry we use ray-tracing analysis to investigate its performance. The TPV design includes the combustion chamber, a cylindrical emitter array, a selective filter, and a cylindrical PV cell bank. FIG. 4 illustrates a schematic representation of the TPV device geometry here considered. A concentric cylindrical configuration is chosen to ensure maximum generated radiation energy flux from the combustion chamber to the PV cells. Using the ray tracing method, we have determined the achievable output electrical power from the TPV system as a function of the combustion chamber surface temperature and on the radius, r₂, of the PV cylindrical array. Here we assume that the length, L, of the working surfaces is 30 cm (see schematics on FIG. 4). Based on this analysis we have determined that a TPV system equipped with a combustion chamber whose surface temperature is 1550K can yield: i) 4 kW-hr when employing a cylindrical GaSb PV cell configuration with r₂=15 cm and ii) 1.5 kW-hr when utilizing a silicon PV cell configuration r₂=30 cm. FIG. 5 illustrates computational results for the output power generated employing GaSb PV cells (FIG. 5a) and for a device using Si PV cells (FIG. 5b). Results are plotted as a function of the combustion chamber surface temperature and the separation distance between the combustion chamber surface and the PV cylindrical cell bank. Larger outer cylinder radii and higher emitter temperatures will readily generate higher electrical powers. For example for the case of Si, a system operating at 1800K (natural gas peak combustion temperature) will generate 6 kW-hr for the same 30 cm radius of the outer cylinder.

Based on the results of the ray tracing analysis, we have designed an optimized combustion chamber fueled by natural gas, whose surface temperature in steady state fuel combustion reaches 1550 K. The design of the combustion chamber is illustrated in FIG. 6. The schematic views are given from the combustion fuel outlet. A side view of the chamber and from the fuel inlet side of the device are illustrated. A 3D sketch of the combustion chamber is also illustrated. All dimensions shown are in cm.

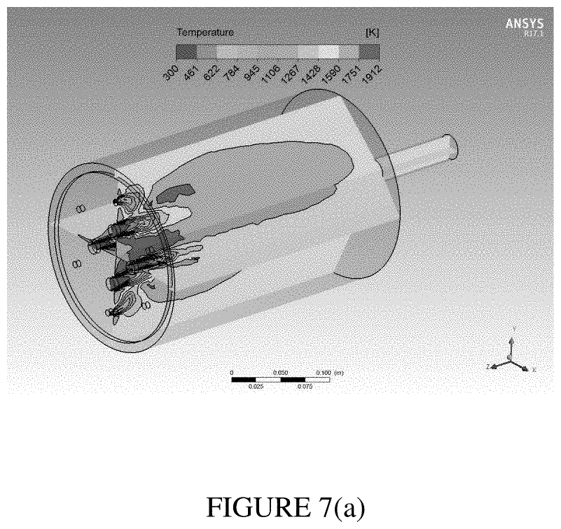

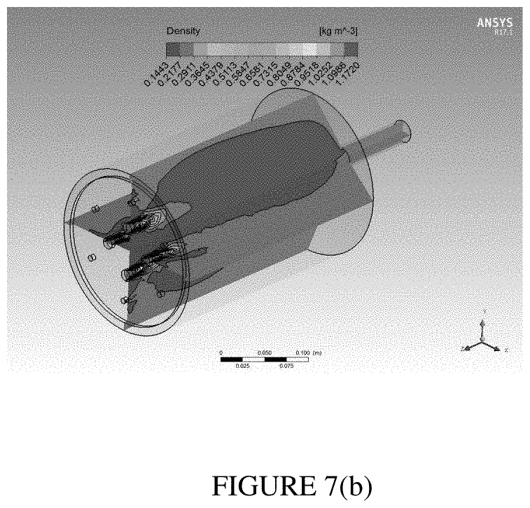

Various embodiments of the present application relate to a cylindrical design chamber employing non-premixed fuels. Optimization is done using a probability density function approach. Fuel (methane) is supplied through six 0.35 cm radius orifices, while air is injected via four 0.7 cm radius inlets. To ensure ideal stoichiometric gas/air mixtures for optimum fuel burning, 5.5% methane with 94.5% air mixtures should be used. Required mass flow rates of 0.0032 kg/s and 0.00012 kg/s for air and methane respectively are estimated. The fuel/air mixture should be preheated to 315 K before injection into the combustion chamber. In FIG. 7 we illustrate calculated fuel temperature and density distributions values inside the combustion chamber during burning. The proposed mixture values and flow rates ensure a combustion chamber surface temperature of 1520 K. Based on the ray tracing analysis, this design is expected to provide approximately 3.4 kW-hr and 1 kW-hr outputs when using GaSb and silicon PV cells, respectively. Improvement in fuel efficiency and thermal transport across the combustion chamber walls are feasible through design changes that deliver and confine the fuel combustion on the vicinity of the chamber walls. Examples of design changes that are expected to improve efficiency include schemes wherein the combustion is localized in the vicinity of the combustion chamber walls rather than across the entire volume of the chamber.

In addition to optimized energy conversion, reliable, long-term operation of TPV devices require solutions to the following engineering problems: i) oxidation prevention of the TiN emitters operating at elevated temperatures for prolonged periods of time; ii) maintaining near-room temperature operation of the PV cell array; iii) ensuring materials stability of the high temperature combustion chamber; iv) optimization of prototype energy conversion efficiency. Here we disclose solutions to these problems as well.

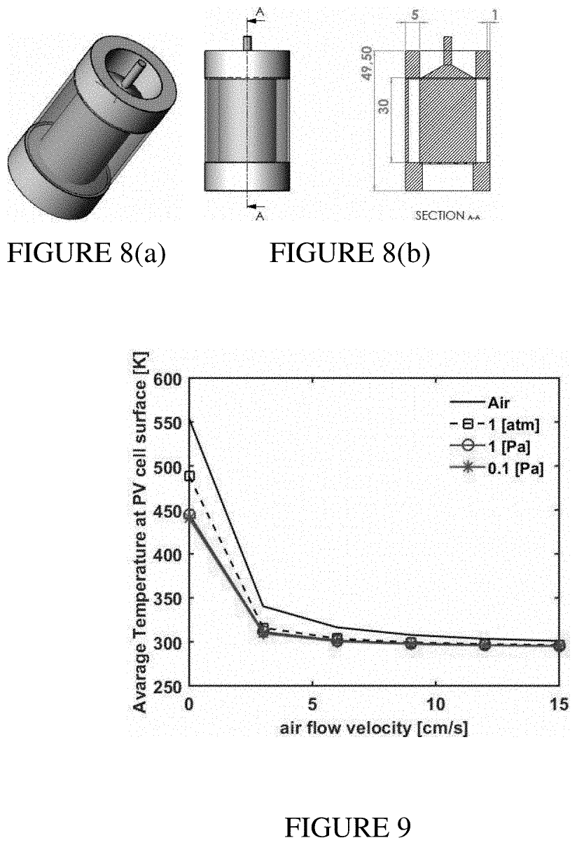

Under extremely high operation temperatures, TiN thin films undergo oxidation reactions when exposed to air. This results in significant changes of their optical and photonic properties. We have experimentally determined that several-nm-thick Si₃N₄ overcoats are efficient barriers to hinder TiN oxidation at ˜1300K in air for several hours. For prolonged (24/7 operation) protection at even higher emitter operating temperatures, thicker overcoats may be needed. However, thicker overcoat layers are expected to modify the metasurface emission spectrum, thereby negatively impacting the TPV conversion efficiency. Therefore, we propose to implement a more reliable solution for prolonged high temperature operation of the emitters. This entails the utilization of an optically transparent enclosure around the hot emitters that can be evacuated to yield modest vacuum pressures in order to remove oxygen and water in the vicinity of the emitters. An additional advantage of such “vacuum jacket” as described in subsequent paragraphs is the suppression of convection heating of the PV cell bank. We propose to employ a quartz cylinder of 1 cm in thickness, as the transmissive window in the visible to near-infrared spectral region as the enclosure surrounding the combustion chamber as schematically illustrated in FIG. 8. The cylinder will be supported by an assembly that allows evacuation of the enclosure between the quartz envelope and the emitters.

One of the key issues limiting the conversion efficiency of PV cells is their operation at elevated temperatures. This is a problem in high temperature TPV systems on account of convection heating and radiative energy transfer from the combustion chamber to the PV array. Our design employing the enclosure described drastically reduces undesirable convection heating of the PV cells. FIG. 9 illustrates numerical results, based on finite-element analysis, of the PV array surface temperature as a function of atmospheric pressure in the enclosure between the quartz envelope and the combustion chamber. The solid line (no symbols) in FIG. 9 corresponds for the case where no quartz enclosure is deployed between the combustion chamber and the PV bank.

As illustrated in FIG. 9, a modest vacuum(dashed and solid lines with symbols) is effective enough to reduce the temperature of the PV cell from ˜550K (no quartz envelope) to 450 K when the vacuum in the enclosure is 1 Pa. A modest air flow velocity within the enclosure of ≥3 cm/s is sufficient to maintain the PV surface temperature in the vicinity of room temperature. Heat removal is more efficient at lower pressures as illustrated in the results of FIG. 9. To maintain the PV array temperature near room temperature, we have designed a support assembly for the PV cells equipped with forced air-cooling as described in subsequent paragraphs. Hence, the quartz cylinder enclosure utilization allows for the reliable operation of our TPV devices. It eliminates the oxidation of the TiN emitters by removal of air around the combustion chamber, and reduces convection heating of the PV array.

As previously stated for a TPV system equipped with GaSb PV cells to generate 3.4 kW-hr electrical power, the combustion chamber surface temperature must operate at or above 1520K. For long-term, reliable TPV operation, the combustion chamber materials need to withstand these high temperatures for prolonged periods of time. The physical properties of refractory metals (W, Mo, Ta) such as high melting points and good thermal conductivity make them ideal materials for fabrication of the combustion chamber. The high melting points of these refractory metals: W=3695K, Mo=2896K and Ta=3290K, render them extremely stable against creep deformation at the 1550K operating temperature of our TPV prototype device. We note that refractory metal alloys of Mo, Nb, Ta and W are commonly employed in space nuclear power systems whose operating temperatures range from 1350K to 1900K. Therefore, materials such refractory metals and their alloys are suitable materials for combustion chamber fabrication. In addition other high temperature materials such as Inconel 600 and ceramic materials such as Alumina, Zirconia, etc, are also suitable.

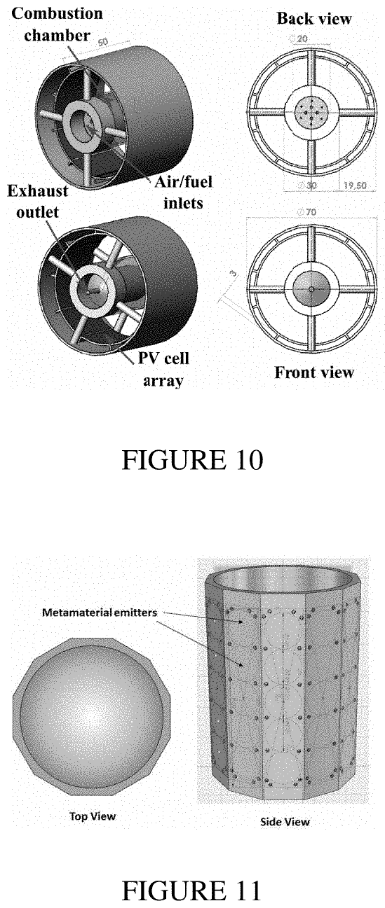

FIG. 10 illustrates conceptual drawings of the TPV assembly: top-left illustrates a 3D perspective seen from the fuel inlet side; lower-left portion provides a perspective as would be seen from the fuel exit point. The proposed TPV prototype includes the combustion chamber, the metamaterial emitters mounted on the combustion chamber outer wall, a cylindrical quartz envelope to form an enclosure between the combustion chamber, and the photovoltaic cell bank that can be evacuated. The PV cells are supported on a cylindrical body that is air-cooled. To achieve the target electrical power output of the TPV prototype, the combustion chamber surface temperature needs to operate near 1550K. The material employed to build the combustion chamber can be selected from the following potential suitable choices: W, Mo, TZM (Ti—Zr—Mo) or superalloy high temperature materials such as Inconel-600. The ideal stoichiometric fuel mixture of 5.5% methane with 94.5% air will be injected into the combustion chamber at the optimum flow rate to attain a stable outer wall surface temperature. This mixture needs to be optimized for combustion chamber designs that aim to provide localized heating of the chamber walls. The combustion products will be exhausted out through a pipe connected to the gas egress port. These hot gases will be re0injected into the gas mixture to raise the temperature of the combustion gases for improving fuel efficiency.

To illustrate the deployment of the metasurface emitters to cover the full surface area of the combustion chamber, we provide a solution to the case where the emitters are fabricated on 2″ diameter sapphire substrates. FIG. 11 illustrates the geometry of the combustion chamber. In order to facilitate attachment of the emitters on the outer wall of the combustor, this outer wall has a polygonal geometry. To maximize the number of rigid 2″ diameter emitters that can be deployed on the 20 cm diameter combustor outer surface, the outer wall is a dodecagonal surface that accommodates 5 emitters on each planar surface. To ensure good thermal conductivity between the combustor outer wall and the emitter substrates, flexible graphite gaskets such as GRAFOIL® can be used. These gaskets are heat-resistant up to 3300K in the absence of oxygen, have high thermal conductivity, and offer chemical resilience in high temperature environments. The 2″ diameter emitters can be mounted onto the combustion chamber with a lattice support and hardware (screws, washers and nuts) made out of Mo. For this type of mechanical assembly of the emitters, the thickness of the combustor chamber walls is chosen as 1.5 cm. This arrangement provides rigid, thermal-conductivity optimized emitter array mounting, as well as it permits removability of emitter units that is anticipated for prototype optimization and maintenance operations of the TPV device. Simpler, bayonet-type of mounting as employed in single-lens-reflex (SLR) cameras is also a versatile solution for the removable mounting of the selective emitters.

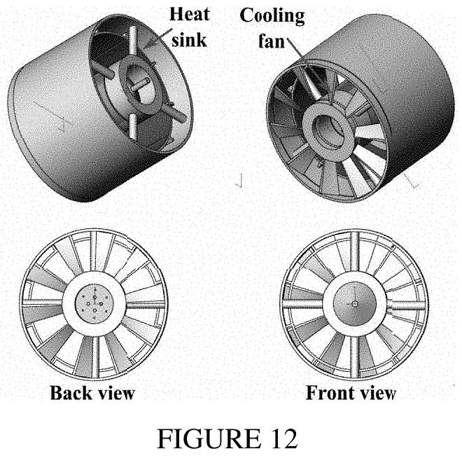

To prevent deleterious convective and radiative overheating of the PV cells, the combustion chamber assembly with the surface-mounted TiN emitters is inserted in the quartz tube and sealed tightly with metal vacuum flanges at both ends. The enclosure between the emitters and the quartz tube can be evacuated and vacuum sealed to maintain a modest vacuum level to avoid oxidation of the emitters and to drastically reduce convection heating of the PV cells. Commercial GaSb and Si PV cells modules will be mounted on the outermost cylindrical component of the TPV system. As illustrated in FIG. 12, this outermost cylindrical structure is designed to utilize forced-air to remove residual heat energy emerging from the quartz envelope and maintain the PV bank operating temperature near 300K. The output of the PV cells will be connected to a charge controller for either DC voltage/current supply utilization or for storage in rechargeable batteries. Battery storage permits powering additional devices or for deriving electricity from the system when the combustion chamber is not in operation. An inverter is utilized for AC voltage/current generation.

Example 1: A system includes a first cylindrical structure embedded into a second cylindrical structure. The first cylindrical structure includes a combustion chamber. The first cylinder additionally includes a plurality of plasmonic materials on an outer wall of the first cylindrical structure. The second cylindrical structure includes a plurality of photovoltaic cells on an inner wall of the second cylindrical structure. A radius of the second cylindrical structure is greater than a radius of the first cylindrical structure.

In one or more embodiments, the system includes an optically transmissive cylindrical structure between the first cylindrical structure and the second cylindrical structure. In at least one embodiment, the optically transmissive cylindrical structure includes quartz. In various embodiments, each plasmonic material of the plurality of plasmonic materials includes titanium nitride (TiN) or zirconium nitride (ZrN).

In one or more embodiments, the system includes a silicon nitride film over the plurality of plasmonic materials. In at least one embodiment, the system includes a second plurality of plasmonic materials over the silicon nitride film, wherein each second plurality of plasmonic materials of the second plurality of plasmonic materials includes titanium nitride (TiN), zirconium nitride (ZrN). In some embodiments, the system includes a second silicon nitride film over the second plurality of plasmonic materials.

In one or more embodiments, each photovoltaic cell of the plurality of photovoltaic cells includes at least one of gallium antimony(GaSb), Silicon (Si), or Indium Gallium Arsenide (InGaAs).

In one or more embodiments, the combustion chamber is made from a material, wherein the material includes at least one of tungsten, tantalum, molybdenum, Inconel (NiCr), alumina, niobium, ceramic materials such as zirconia, or high temperature superalloys.

In one or more embodiments, the first cylindrical structure is made from a material, wherein the material includes at least one of tungsten, Inconel (NiCr), tantalum, molybdenum, alumina, niobium, ceramic materials such as zirconia, or high temperature superalloys.

In one or more embodiments, a first end of the first cylindrical structure includes at least one of air inlet or fuel inlet. A second end of the first cylindrical structure comprises an exhaust outlet. In at least one embodiment, the system further includes a cooling fan on the second end of the first cylindrical structure. In some embodiments, the system further includes a heat sink on the second end of the first cylindrical structure.

In one or more embodiments, each plasmonic material of the plurality of plasmonic materials is a meta-material. In various embodiments, each plasmonic material of the plurality of plasmonic materials is configured to match a bandgap of each photovoltaic cell of the plurality of photovoltaic cells.

Example 2: A system includes a first cylindrical structure embedded into a second cylindrical structure. The first cylindrical structure includes a chamber, wherein the chamber includes an isotope. The first cylinder additionally includes a plurality of plasmonic materials on an outer wall of the first cylindrical structure. The second cylindrical structure includes a plurality of photovoltaic cells on an inner wall of the second cylindrical structure. A radius of the second cylindrical structure is greater than a radius of the first cylindrical structure.

In one or more embodiments, the system includes an optically transmissive cylindrical structure between the first cylindrical structure and the second cylindrical structure. In at least one embodiment, the optically transmissive cylindrical structure includes quartz. In various embodiments, each plasmonic material of the plurality of plasmonic materials includes titanium nitride (TiN) or zirconium nitride (ZrN).

In one or more embodiments, the system includes a silicon nitride film over the plurality of plasmonic materials. In at least one embodiment, the system includes a second plurality of plasmonic materials over the silicon nitride film, wherein each second plurality of plasmonic materials of the second plurality of plasmonic materials includes titanium nitride (TiN), zirconium nitride (ZrN). In some embodiments, the system includes a second silicon nitride film over the second plurality of plasmonic materials.

In one or more embodiments, each photovoltaic cell of the plurality of photovoltaic cells includes at least one of gallium antimony(GaSb), Silicon (Si), or Indium Gallium Arsenide (InGaAs).

In one or more embodiments, the combustion chamber is made from a material, wherein the material includes at least one of tungsten, tantalum, molybdenum, Inconel (NiCr), alumina, niobium, ceramic materials such as zirconia, or high temperature superalloys.

In one or more embodiments, the first cylindrical structure is made from a material, wherein the material includes at least one of tungsten, Inconel (NiCr), tantalum, molybdenum, alumina, niobium, ceramic materials such as zirconia, or high temperature superalloys.

In one or more embodiments, a first end of the first cylindrical structure includes at least one of air inlet or fuel inlet. A second end of the first cylindrical structure comprises an exhaust outlet. In at least one embodiment, the system further includes a cooling fan on the second end of the first cylindrical structure. In some embodiments, the system further includes a heat sink on the second end of the first cylindrical structure.

In one or more embodiments, each plasmonic material of the plurality of plasmonic materials is a meta-material. In various embodiments, each plasmonic material of the plurality of plasmonic materials is configured to match a bandgap of each photovoltaic cell of the plurality of photovoltaic cells.

Example 3: A method of using a thermophotovoltaic system includes reacting a chemical in a chamber of a first cylindrical structure, wherein the first cylindrical structure includes the chamber. The method additionally includes radiating heat from the chamber onto a plurality of plasmonic materials, wherein the plurality of plasmonic materials are on an outer wall of the first cylindrical structure. The method further includes emitting a wavelength from the plurality of plasmonic materials onto a plurality of photovoltaic cells, wherein a second cylindrical structure includes the plurality of photovoltaic cells. The first cylindrical structure is embedded into the second cylindrical structure. The wavelength emitted from the plurality of plasmonic materials is commensurate with a bandgap of the plurality of photovoltaic cells. Moreover, the method includes producing electric charge from the plurality of photovoltaic cells.

In one or more embodiments, the system includes an optically transmissive cylindrical structure between the first cylindrical structure and the second cylindrical structure. In at least one embodiment, the optically transmissive cylindrical structure includes quartz. In various embodiments, each plasmonic material of the plurality of plasmonic materials includes titanium nitride (TiN) or zirconium nitride (ZrN).

In one or more embodiments, the system includes a silicon nitride film over the plurality of plasmonic materials. In at least one embodiment, the system includes a second plurality of plasmonic materials over the silicon nitride film, wherein each second plurality of plasmonic materials of the second plurality of plasmonic materials includes titanium nitride (TiN), zirconium nitride (ZrN). In some embodiments, the system includes a second silicon nitride film over the second plurality of plasmonic materials.

In one or more embodiments, each photovoltaic cell of the plurality of photovoltaic cells includes at least one of gallium antimony(GaSb), Silicon (Si), or Indium Gallium Arsenide (InGaAs).

In one or more embodiments, the combustion chamber is made from a material, wherein the material includes at least one of tungsten, tantalum, molybdenum, Inconel (NiCr), alumina, niobium, ceramic materials such as zirconia, or high temperature superalloys.

In one or more embodiments, the first cylindrical structure is made from a material, wherein the material includes at least one of tungsten, Inconel (NiCr), tantalum, molybdenum, alumina, niobium, ceramic materials such as zirconia, or high temperature superalloys.

In one or more embodiments, a first end of the first cylindrical structure includes at least one of air inlet or fuel inlet. A second end of the first cylindrical structure comprises an exhaust outlet. In at least one embodiment, the system further includes a cooling fan on the second end of the first cylindrical structure. In some embodiments, the system further includes a heat sink on the second end of the first cylindrical structure.

In one or more embodiments, each plasmonic material of the plurality of plasmonic materials is a meta-material.

One of ordinary skill in the art would recognize that operations are added or removed from method, in one or more embodiments. One of ordinary skill in the art would also recognize that an order of operations in the above method is able to be changed, in some embodiments.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, design, machine, manufacture, and composition of matter, means, methods and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

1. A system comprising:
a first cylindrical structure embedded into a second cylindrical structure, wherein the first cylindrical structure comprises:
a combustion chamber; and
a plurality of plasmonic materials on an outer wall of the first cylindrical structure;
wherein the second cylindrical structure comprises:
a plurality of photovoltaic cells on an inner wall of the second cylindrical structure,
wherein a radius of the second cylindrical structure is greater than a radius of the first cylindrical structure.

2. The system of claim 1, further comprising an optically transmissive cylindrical structure between the first cylindrical structure and the second cylindrical structure.

3. The system of claim 1, wherein each plasmonic material of the plurality of plasmonic materials comprises titanium nitride (TiN) or zirconium nitride (ZrN).

4. The system of claim 1, further comprising a silicon nitride film over the plurality of plasmonic materials.

5. The system of claim 4, further comprising a second plurality of plasmonic materials over the silicon nitride film, wherein each second plurality of plasmonic materials of the second plurality of plasmonic materials comprises titanium nitride (TiN), zirconium nitride (ZrN).

6. The system of claim 1, wherein each photovoltaic cell of the plurality of photovoltaic cells comprises at least one of gallium antimony(GaSb), Silicon (Si), or Indium Gallium Arsenide (InGaAs).

7. The system of claim 1, wherein the combustion chamber is made from a material, wherein the material comprises at least one of tungsten, tantalum, molybdenum, Inconel (NiCr), alumina, niobium, or zirconia.

8. The system of claim 1, wherein the first cylindrical structure is made from a material, wherein the material comprises at least one of tungsten, Inconel (NiCr), tantalum, molybdenum, alumina, niobium, or zirconia.

9. The system of claim 1, wherein a first end of the first cylindrical structure comprises at least one of air inlet or fuel inlet.

10. The system of claim 1, wherein a second end of the first cylindrical structure comprises an exhaust outlet.

11. The system of claim 10, further comprising a cooling fan on the second end of the first cylindrical structure.

12. The system of claim 10, further comprising a heat sink on the second end of the first cylindrical structure.

13. The system of claim 1, wherein each plasmonic material of the plurality of plasmonic materials is a meta-material.

14. The system of claim 2, wherein the optically transmissive cylindrical structure comprises quartz.

15. The system of claim 5, further comprising a second silicon nitride film over the second plurality of plasmonic materials.

16. The system of claim 1, wherein each plasmonic material of the plurality of plasmonic materials is configured to match a bandgap of each photovoltaic cell of the plurality of photovoltaic cells.

17. A system comprising:
a first cylindrical structure embedded into a second cylindrical structure, wherein the first cylindrical structure comprises:
a chamber, wherein the chamber comprises an isotope; and
a plurality of plasmonic materials on an outer wall of the first cylindrical structure;
wherein the second cylindrical structure comprises:
a plurality of photovoltaic cells on an inner wall of the second cylindrical structure,
wherein a radius of the second cylindrical structure is greater than a radius of the first cylindrical structure.

18. The system of claim 17, wherein each plasmonic material of the plurality of plasmonic materials is configured to match a bandgap of each photovoltaic cell of the plurality of photovoltaic cells.

19. A method of using a thermophotovoltaic system comprising:
reacting a chemical in a chamber of a first cylindrical structure, wherein the first cylindrical structure comprises the chamber;
radiating heat from the chamber onto a plurality of plasmonic materials, wherein the plurality of plasmonic materials are on an outer wall of the first cylindrical structure;
emitting a wavelength from the plurality of plasmonic materials onto a plurality of photovoltaic cells, wherein a second cylindrical structure comprises the plurality of photovoltaic cells, wherein the first cylindrical structure is embedded into the second cylindrical structure, and wherein the wavelength emitted from the plurality of plasmonic materials is commensurate with a bandgap of the plurality of photovoltaic cells; and
producing electric charge from the plurality of photovoltaic cells.

20. The method of claim 19, wherein the reacting the chemical in the chamber of the first cylindrical structure comprises:
reacting a fossil fuel in the chamber of the first cylindrical structure; or
reacting an isotope in the chamber of the first cylindrical structure.
